(19) United States
(12) Patent Application Publication
(10) Pub. No.: US 2023/0068451 A1
(43) Pub. Date: Mar. 2, 2023

(54) METHODS AND APPARATUS TO THERMALLY ACTUATE MICROELECTROMECHANICAL STRUCTURES DEVICES

(71) Applicant: Texas Instruments Incorporated, Dallas, TX (US)

(72) Inventors: Bichoy Bahr, Allen, TX (US); Adam Fruehling, Garland, TX (US); Scott Summerfelt, Garland, TX (US)

(21) Appl. No.: 17/461,235

(22) Filed: Aug. 30, 2021

(51) Int. Cl. H01H 37/32; H01H 37/04; H01H 37/64

(52) U.S. Cl. CPC H01H 37/32; H01H 37/04; H01H 37/64

(57) ABSTRACT

An example microelectromechanical structures (MEMS) switch includes a body having a first end and a second end opposite the first end. The body extends from a base at the first end and has a first width. The MEMS switch further includes a bridge extending laterally from the body at the second end, and a spine extending between the bridge and the base. The spine has a second width smaller than the first width. At least one of the spine or the body includes a first material with a first thermal coefficient and a second material with a second thermal coefficient different from the first thermal coefficient.

### TECHNICAL FIELD

This description relates generally to microelectromechanical structures (MEMS) devices, and more particularly to methods and apparatus to thermally actuate MEMS devices.

### BACKGROUND

Microelectromechanical structures (MEMS) devices can perform a wide variety of functions, such as, for example, moving portions to actuate and/or toggle a MEMS switch between on and off states. However, due to a significant number of actuation cycles, the MEMS switch can experience long-term wear and/or damage. Particularly, the MEMS switch can be subject to stiction in which a movable contact portion of the MEMS switch remains coupled or stuck to an electrical contact and, thus, the MEMS switch becomes unresponsive (i.e., in a closed state). In other words, the movable contact portion can remain stuck or fused, thereby rendering the MEMS switch inoperable and stuck in a closed state.

### SUMMARY

To thermally actuate microelectromechanical structures (MEMS), an example MEMS switch includes a body having a first end and a second end opposite the first end. The body extends from a base at the first end and has a first width. The MEMS switch further includes a bridge extending laterally from the body at the second end, and a spine extending between the bridge and the base. The spine has a second width smaller than the first width. At least one of the spine or the body includes a first material with a first thermal coefficient and a second material with a second thermal coefficient different from the first thermal coefficient.

### BRIEF DESCRIPTION OF THE DRAWINGS

FIGS. 1A-1C illustrate an example microelectromechanical structures (MEMS) device in accordance with teachings of this disclosure.

FIGS. 2A and 2B illustrate example movement of the example MEMS device of FIGS. 1A-1C.

FIGS. 3A and 3B illustrate example power usage of the example MEMS device of FIGS. 1A-1C.

FIG. 4 illustrates an alternative example MEMS device in accordance with teachings of this disclosure.

FIGS. 5A and 5B illustrate another alternative example MEMS device in accordance with teachings of this disclosure.

FIG. 6 illustrates example movement of the example MEMS device of FIGS. 5A and 5B.

FIG. 7 is a flowchart representative of an example method that may be performed to implement examples disclosed herein.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show layers and regions with clean lines and boundaries, some or all of these lines and/or boundaries may be idealized. In reality, the boundaries and/or lines may be unobservable, blended and/or irregular.

Methods and apparatus to thermally actuate microelectromechanical structures (MEMS) devices are disclosed. Some known MEMS devices have movable portions that can be subjected to a relatively large amount of actuation cycles. For example, a MEMS switch typically has a movable body that is moved to contact a contact pad over numerous actuation cycles (e.g., thousands or millions of actuation cycles). The movable body can remain stuck to the contact pad after a certain number of repeated actuation cycles, which is typically referred to as stiction. Stiction can render the MEMS switch inoperable. Furthermore, under certain input power conditions, the device can fail to move to a commanded state due to RF latch, or can be subject to collapse based on the sudden onset of power. Further, the parallel plate forces are inherently hysteretic in relative to gap, thus, lower RF power can maintain a device to be turned on even if a control voltage is not provided. To address stiction, some known implementations employ non-linear spring stiffening, but these implementations can be complicated and, thus, difficult to control. Some known comb actuators can be implemented to address stiction, but the comb actuators can take up a relatively large device area, and for RF applications, impart excessive parasitic capacitance. Known pull-in/pull-out actuators can also be subject to premature wear due to their relatively large degree of displacement and typically require larger voltages for pull-out due to the increased gap from the neutral state.

Examples disclosed herein can reduce a probability of stiction, thereby improving long-term reliability of MEMS devices that utilize movable portions, such as MEMS switches. Accordingly, examples disclosed herein can be implemented to significantly improve overall device reliability. Examples disclosed herein are compact and power efficient. Further, examples disclosed herein can enable a higher amount of RF power compared to known implementations. Some examples disclosed herein can also greatly improve reliability by enabling contact of a movable portion of a MEMS device and a corresponding contact pad at random positions of the contact pad.

Examples disclosed herein include a MEMS device (e.g., a MEMS switch device, a MEMS switch circuit, etc.) having a movable body that extends from a base and has a first width. A bridge extends from the body to support a spine having a second width smaller than the first width. At least one of the spine or the body includes a first material with a first thermal coefficient (i.e. a thermal coefficient of expansion) and a second material with a second thermal coefficient different from that of the first material, thereby defining a thermal coefficient mismatch therebetween. A current is applied to the spine, thereby causing the spine and, in turn, the body to heat up. In turn, the increase in heat causes the body to move and/or bend relative to a contact pad based on the thermal coefficient mismatch. In some examples, the first and second materials define different layers of the MEMS device, the body and/or the spine.

In some examples, the body includes a pattern of apertures. In some examples, the bridge is at least composed of and/or includes a dielectric material. In some examples, the first material includes tungsten or platinum. In some examples, the second material includes silicon dioxide (SiO₂) or titanium. In some examples, a ratio of the second width to the first width is equal to a value in a range from 1:3 to 1:80. However, any other appropriate ratio can be implemented instead. In some examples, the body electrically couples an RF input to an RF output. In some such examples, the body and the spine are electrically isolated from the RF input and the RF output, thereby reducing noise that can leak into an RF signal associated with the RF input and the RF output. In some examples, the spine is actuated in a range between 1000 hertz (Hz) to 100,000 Hz or with a specific waveform known to promote release. This tone or waveform can therefore motivate a dynamic release of the body from the contact surface.

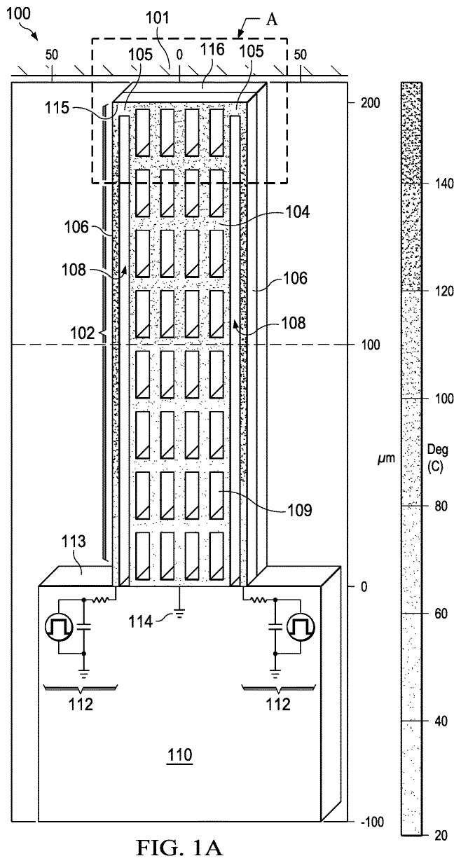

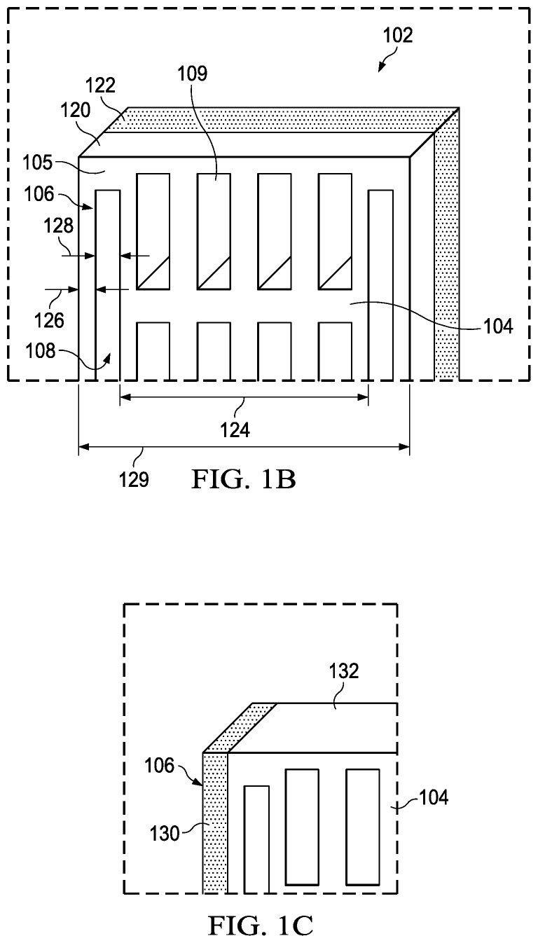

FIGS. 1A-1C illustrate an example MEMS device (e.g., a MEMS switch, a MEMS switch circuit, etc.) 100 in accordance with teachings of this disclosure. In the illustrated example, the MEMS device 100 is implemented as a MEMS switch that is operated to move a movable portion 102 relative to a contact pad 101 for electrical coupling thereto. The example movable portion 102 includes a body (e.g., a main portion, a wider portion, a main electrical coupling, a main movement portion, etc.) 104, and spines (e.g., arms, bendable spines, heating spines, etc.) 106 with gaps 108 between the spines 106 and the body 104. The example body 104 includes a pattern of apertures 109, which are generally rectangular shaped and spaced at regular intervals (e.g., vertically and horizontally in the view of FIG. 1A). However, the apertures 109 can be any appropriate shape including, but not limited to, oval-like, circular, triangular, oblong, etc. Further, in this example, the body 104 and the spines 106 extend from a base 110 (vertically in the view of FIG. 1A), at which at least one current source 112 and ground (e.g., a ground contact position, a ground interconnect, a ground pad, etc.) 114 are positioned and/or supported.

According to the illustrated example, the body 104 extends from the base 110 at a first end 113 of the body 104. In turn, each of the example bridges 105 extends laterally (in the view of FIG. 1A) from the body 104 at a second end (e.g., a distal end) 115 of the body 104 opposite the first end 113. In this example, each of the spines 106 extend between the base 110 and the respective bridge 105 along a direction that is substantially parallel to a longitudinal direction of the body 104. In the illustrated example, the second end 115 of the body 104 defines a contact portion 116 to contact and/or be move relative to the aforementioned contact pad 101. In particular, during primary operation, at least one mechanism and/or device is utilized to move the body 104 to toggle the MEMS device 100 between on and off states.

To reduce and/or mitigate stiction between the body 104 and the contact pad 101 that may or may not result from the primary operation of the MEMS device 100, the body 104 is moved relative to the contact pad 101. In particular, the movable portion 102 of the illustrated example is caused to move based on an applied current from the current source(s) 112 to the spines 106. As a result, the current causes the spines 106 to increase in temperature due to the spines 106 having relatively small cross-sectional areas compared to the body 104. Therefore, the spines 106 will exhibit more rapid heating and, thus, greater thermal expansion, thereby imparting a lateral force to the body 104. Over longer timescales, the body 104 is also heated based on thermal conduction between the spines 106 and the body 104 causing a secondary deflection vector. As will be discussed in greater detail below in connection with FIG. 1B, at least one of the body 104 or the spines 106 includes a first material 120 (shown in FIG. 1B) having a first thermal coefficient (e.g., a thermal coefficient of expansion) and a second material 122 (also shown in FIG. 1B) having a second thermal coefficient different from the first thermal coefficient. As a result, the first and second materials 120, 122 define a thermal coefficient mismatch therebetween. In this example, the first material 120 and the second material 120 are arranged in a layered construction at separate layers. However, any other appropriate arrangement of the first and second materials 120, 122 can be implemented instead. Due to the thermal coefficient mismatch, heating the body 104 causes the body 104 to bend, rotate and/or move in flexure and, thus, at least a portion of the body 104 (e.g., a portion of the body 104 near a distal end thereof) moves relative to the contact pad 101. In this example, the apertures 109 are defined in the body 104 and spaced apart at regular intervals to advantageously enable a relatively uniform and energy-efficient bending of the body 104. Further, the relative placement and/or positioning of the spines 106 to the body 104 advantageously facilitates efficient heat transfer from the spines 106 to the body 104, as well as enable accurate control of movement of the body 104.

To generate heat at and/or heat the spines 106, the current source(s) 112 are implemented to provide current to the respective spines 106 from the base 110 and, in turn, the current returns to the ground 114 via the body 104. In this example, the relatively small cross-sectional area of the spines 106 in combination with the current applied thereto causes the spines 106 to advantageously generate a significant amount of heat. Additionally or alternatively, a thermally resistant material is implemented in the spines 106 to facilitate generation of relatively localized heat at the spines 106. In some examples, the current sources(s) 112 provide current in the form of a waveform and/or pulse (e.g., a pulse waveform) to promote release of the body 104 from the contact pad 101. The waveform may be similar to that of a digital light projection (DLP) dynamic release waveform.

As can be seen in the illustrated example of FIG. 1A, which also depicts example thermal gradients, the heating of the spines 106 causes significant thermal gradients across the movable portion 102, thereby causing the body 104 and the spines 106 to move and/or bend in flexure based on the aforementioned thermal coefficient mismatch. To that end, the relatively small sizes (e.g., widths in the view of FIG. 1A) of the spines 106 compared to the body 104 advantageously enable the spines 106 to move with significant flexure as they heat the body 104, for example. In other words, the relative sizes of the spines 106 to the body 104 advantageously enables a high degree of consistent flexure of the movable portion 102.

In some examples, different and/or varying current amounts (e.g., based on providing random current amounts determined at intervals that may be periodic) are provided to the spines 106 to randomize a contact position of the body 104 with the contact pad 101 at the contact portion 116. In some examples, the current source 112 is implemented as a secondary mechanism (e.g., a supplemental mechanism, a backup mechanism, an auxiliary mechanism, etc.) for moving the body 104. In some such examples, the current source 112 is periodically operated to reduce and/or minimize a probability of stiction between the contact portion 116 of the body 104 and the contact pad 101 and/or another component to be coupled to and/or to be moved by the body 104. Additionally or alternatively, the current is applied to the spines 106 during (e.g., simultaneously with) primary operation of the body 104 (e.g., via another movement mechanism or device separate from generating heat at the spines 106). In some examples, only one of the current sources 112 is utilized to provide current to multiple ones of the spines 106 (e.g., the spines 106 utilize the same current source 112). However, any appropriate number of the current sources 112 can be implemented instead.

In some other examples, the apertures 209 are not implemented. In some examples, only one of the spines 106 is implemented to heat and/or move the body 104. While the body 104 and/or the movable portion 102 has an overall rectangular shape and/or outline, any appropriate shape including, but not limited to, ellipsoid, trapezoidal, hexagonal, etc. can be implemented instead. In some examples, the contact portion 116 of the body 104 includes a curved or acuate shape. In the example shown, the spines 106 are shown symmetrically arranged relative to the body 104 (e.g., to a center line of the body 104). However, in other examples, the spines 106 are not symmetrically arranged and/or positioned relative to the body 104 (e.g., the spines 106 are spaced differently and/or are sized differently from one another to define an asymmetric arrangement of the spines 106).

Turning to FIG. 1B, a detailed view of a region A of FIG. 1A is shown. In the illustrated example of FIG. 1B, the movable portion 102 is depicted with the body 104 and the spines 106 extending along a longitudinal direction of the body 104. As mentioned above, the example spines 106 are separated from the body 104 by the gaps 108.

In the illustrated example, the movable portion 102 includes the aforementioned first material 120 and the second material 122. As mentioned above in connection with FIG. 1A, the first material 120 is a different material from the second material 122 and includes the first thermal coefficient (i.e., a first thermal coefficient of expansion) different from the second thermal coefficient of the second material 122. As can be seen in FIG. 1B, the first material 120 and the second material 122 are implemented as separate layers along a depth of the movable portion 102. In other words, the first material 120 and the second material 120 extend along different depths and/or depth portions of the movable portion 102. In some other examples, the movable portion 102 includes another portion in which the first material 120 and the second material 122 are reversed along the depth of the movable portion 102 from the portion shown in FIG. 1B. In some such examples, the reversed first material 120 and the second material 122 can be heated to advantageously enable a flexure of the movable portion 102 in a reverse direction (e.g., via a different current source).

In this example, the first material 120 is at least partially composed of tungsten and the second material 122 is at least partially composed of silicon dioxide. Further, the example first material 120 and the example second material 122 are each approximately 0.5 micrometers (μm) in thickness/depth. However, any appropriate material combinations and thicknesses can be implemented instead. In some examples, the first material 120 and the second material 122 are implemented with (e.g., layered with) different thicknesses from one another. Additionally or alternatively, the first material 120 can be at least partially composed of platinum. The second material 122 can be at least partially composed of titanium, aluminum dioxide (AlO₂), aluminum, iridium oxide and/or aluminum nitride. However, any appropriate combination of materials and/or alloys can be implemented instead. In some examples, only the body 104 includes the first material 120 and the second material 122 (e.g., the thermal coefficient mismatch is at the body 104 and not the spines 106). In some other examples, the spines 106 include the first material 120 while the body 104 includes the second material 122.

In this example, the body 104 includes an overall width 124. Further, the spines 106 each have widths 126 while the gap 108 includes a gap width 128. Moreover, the movable portion 102 includes a width 129 that encompasses the spines 106, the body 104 and the bridges 105. A ratio between the width 126 of each of the spines 106 to the width 124 of the body 104 may be equal to a range from 1:3 to 1:80, for example. However, any other appropriate ratios can be implemented instead.

Turning to FIG. 1C, an alternative example implementation of the MEMS device 100 is shown. In the illustrated example of FIG. 1C, the spine 106 is depicted having a first material 130 and a second material 132 with a different thermal coefficient from that of the first material 130. In contrast to the example of FIG. 1A, the spine 106 includes the second material 132 at a different lateral position and/or layer from that of the first material 130. However, any appropriate arrangement of the first material 130 and the second material 132 can be implemented instead. In contrast to the example of FIGS. 1A and 1C, current applied from the current source 112 causes the body 104 to move laterally (side to side in the view of FIG. 1C). Additionally or alternatively, the body 104 includes the materials 130, 132 at different lateral positions thereof. In other examples, the body 104 and/or the spine 106 includes different materials with different thermal coefficients positioned at different longitudinal positions thereof.

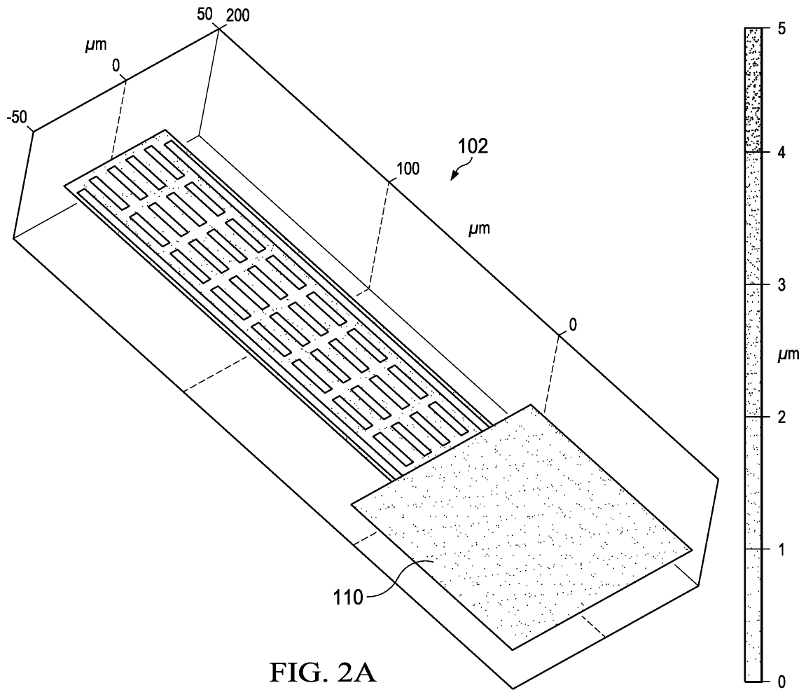

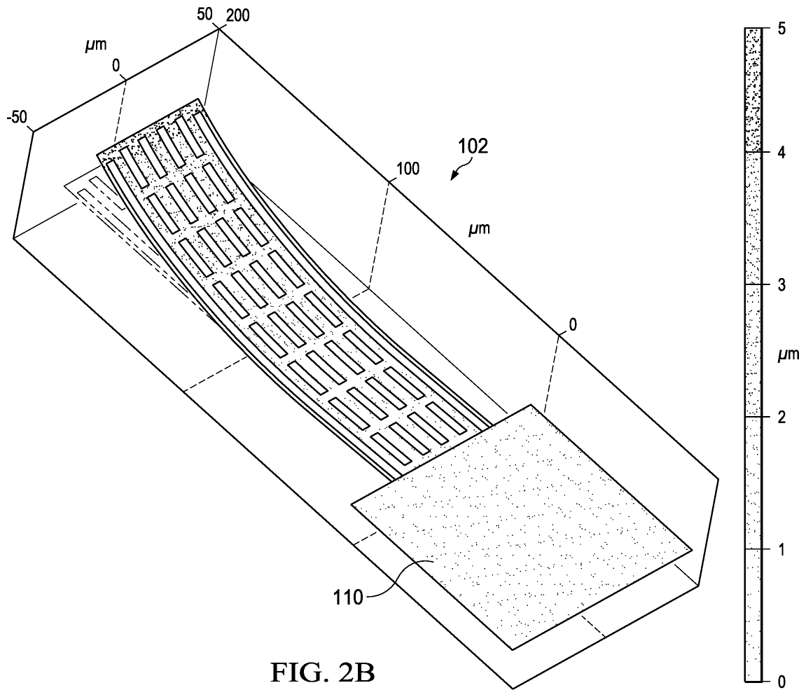

FIGS. 2A and 2B illustrate example movement of the example MEMS device 100 of FIGS. 1A-1C. Turning to FIG. 2A, an example displacement of the example movable portion 102 relative to the base 110 is depicted without current applied to the movable portion 102 and/or the spines 106 shown in FIGS. 1A and 1B. In other words, FIG. 2A depicts the movable portion 102 in a neutral or unmoved state.

In contrast to the view of FIG. 2A, FIG. 2B depicts example displacement of the example movable portion 102 relative to the base 110 while current is applied to the movable portion 102 and/or the spines 106 shown in FIGS. 1A and 1B. In this particular example, the movable portion 102 has a peak displacement of approximately 25-30 micrometers (μm), However, the aforementioned example peak displacement is only an example and displacements may vary based on geometry, relative dimensions of the spine 106 to the body 104, material selection, applied current, etc.

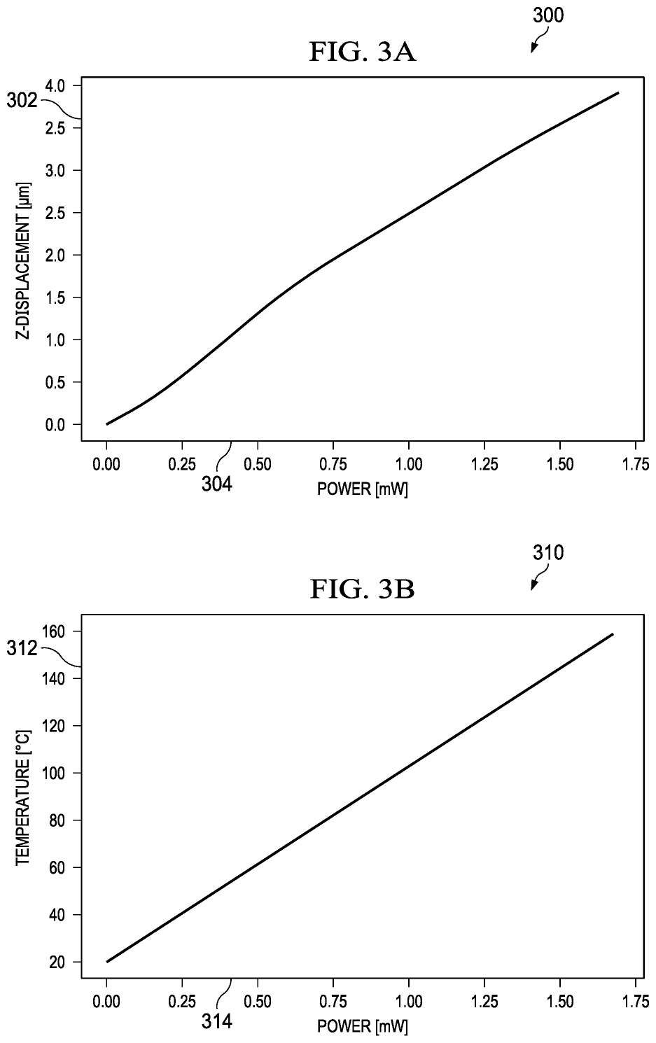

FIGS. 3A and 3B illustrate example power usage of the example MEMS device 100 of FIGS. 1A-1C. FIG. 3A depicts a graph 300 having a first axis 302 corresponding to displacement and a second axis 304 corresponding to a power input to the MEMS device 100. As can be seen in the example of FIG. 3A, examples disclosed herein can advantageously displace portions thereof with relatively little power provided thereto.

FIG. 3B depicts a graph 310 having a first axis 312 corresponding to temperature and a second axis 314 corresponding to a power input to the example MEMS device 100. As can be seen in the example of FIG. 3B, examples disclosed herein can advantageously increase temperatures with relatively little power. Further, relatively large thermal gradients are seen across the example MEMS device 100, as previously shown above in connection with FIG. 1A.

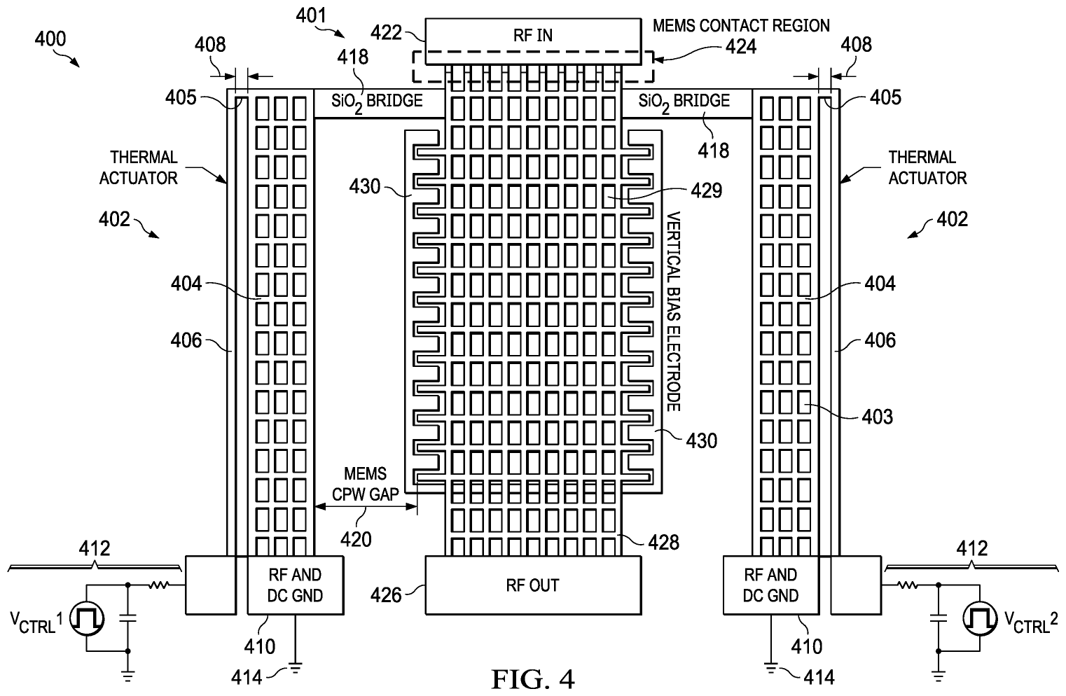

FIG. 4 illustrates an alternative example MEMS device 400 in accordance with teachings of this disclosure. The example MEMS device 400 is similar to the example MEMS device 100, but is, instead, implemented to electrically isolate stiction mitigating portions from a switchable RF coupling. The MEMS device 400 of the illustrated example can be implemented in a co-planar waveguide, for example, and includes movable portions 402 that are laterally arranged (in the view of FIG. 4) relative to an RF portion (e.g., an RF switching portion) 401. In this example, the movable portions 402 each include a corresponding body 404 with a pattern of apertures 403, and spines 406 with a gap 408 defined therebetween. In this example, the spines 406 are attached to the corresponding bodies 404 via bridges 405. The example movable portions 402 extend from a corresponding base 410. Further, the example bases 410 each support and/or hold corresponding current sources 412 and ground (e.g., ground contact points, ground returns, etc.) 414.

In this example, each of the movable portions 402 are attached to (e.g., mechanically coupled to) the RF portion 401 via bridges (e.g., dielectric bridges) 418, both of which are at least partially composed of silicon dioxide in this example. However, any other appropriate dielectric material can be implemented instead. In some other examples, the bridges 418 are electrically conductive. In this example, the RF portion 401 is separated from the movable portions 402 by a gap (e.g., a MEMS coplanar waveguide gap) 420 and is implemented to electrically couple an RF input 422 at a contact interface region 424 to an RF output 426. In this example, a body 428 having a pattern of apertures 429 is integral with and/or coupled to (e.g., fixed to) the RF output 426 and extends between the RF input 422 and the RF output 426. In this example, a vertical bias electrode 430 is coupled and/or attached to the body 428. The vertical bias electrode 430 may be implemented as a primary mechanism for moving the body 428 (e.g., during normal operation of the MEMS device 400) while the movable portions 402 are utilized to reduce stiction that results from utilizing the vertical bias electrode 430. In other words, the movable portions 402 can operate as supplementary movement devices to a primary mechanism, such as the vertical bias electrode 430.

To move the body 428 in a first primary mode (e.g., a primary mode for actuating the MEMS device 400), the vertical bias electrode 430 is implemented to move the body 428 between contacting the RF input 422 and being decoupled from the RF input 422. In this example, the vertical bias electrode 430 is implemented to vary a longitudinal length and/or vertical position (up and down in the view of FIG. 4) of the body 428 to vary a relative position and/or degree of contact between the body 428 and the RF input 422 at the contact interface portion 424.

For prevention or mitigation of stiction by using a second auxiliary mode (e.g., a backup mode, a stiction prevention mode, a stiction mitigation mode, etc.), the movable portions 402 and, in turn, the body 428 of the RF portion 401 are moved by current provided to the spines 406 via the respective current sources 412. The current from the current sources 412 flows through the spines 406, through the bodies 404 and returns to the ground 414. As a result, the heating of the spines 406 causes the bodies 404, which include different materials having different thermal coefficients, to move (e.g., bend in flexure), thereby causing the body 428 to move relative to the RF input 422 at the contact interface region 424. In this example, the movable portions 402 and the current flowing therethrough are electrically isolated from the RF input 422 and the RF output 426 of the RF portion 401 by the bridges 418, thereby advantageously providing significant noise protection and/or isolation. In some examples, the movable portions 402 are caused to move when a certain number of actuation cycles of the body 428 has been exceeded and/or an operational time exceeds a threshold. Additionally or alternatively, at least one of the movable portions 402 are caused to move when stiction has been detected/determined (e.g., based on a lack of ability to toggle the MEMS device 400, based on a sensor that determines that the body 428 cannot move, etc.).

While two of the movable portions 402 are implemented in this example, any other appropriate number of the movable portions 402 can be implemented instead (e.g., one, three, five, ten, twenty, etc.). In some examples, the movable portions 402 are actuated in a range from 1,000 hertz (Hz) to 100,000 Hz. In some examples, at least one of the movable portions 402 are provided with random and/or varying amounts of current to randomize a contact point between the body 428 and the RF input 422. In some examples, one of the movable portions 402 are caused to move at different times. In some such examples, only one of the movable portions 402 are caused to move. Additionally or alternatively, the movable portions 402 are simultaneously operated with the vertical bias electrode 430.

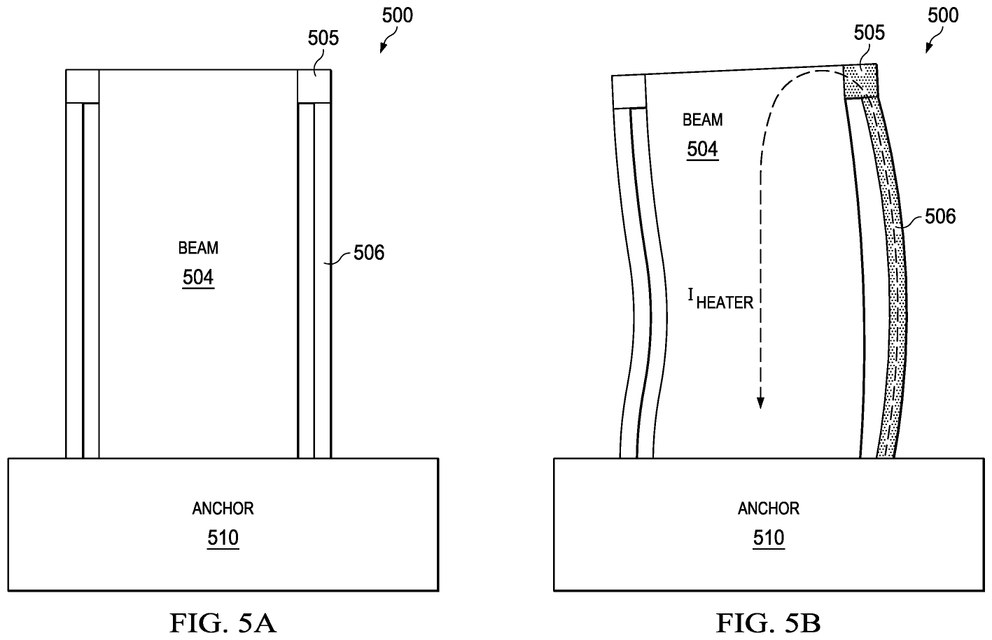

FIGS. 5A and 5B illustrate another example MEMS device 500 in accordance with teachings of this disclosure. The MEMS device 500 is similar to the MEMS devices 100, 400, but instead primarily utilizes lateral motion. Turning to FIG. 5A, a top view of the example MEMS device 500 is shown. In the illustrated view of FIG. 5A, the example MEMS device 500 is depicted being in a neutral position in which no current is applied. The MEMS device 500 of the illustrated example includes a body (e.g., a beam) 504, bridges 505, a spine 506 and a base 510. In this example, the body 504 and the spines 506 extend from the base 510. Further, the spines 506 are attached to the body 504 via the respective bridges 505.

Turning to FIG. 5B, the example MEMS device 500 is shown with current provided to at least one of the spines 506. In particular, the current is provided to the spine 506 and flows through the bridge 505 and the body 504, and subsequently returns to the base 510. In this example, a thermal coefficient mismatch of different materials of at least one of the spine 506 or the body 504 causes the body 504 to move in a lateral motion (left and right in the view of FIG. 5B) and/or a twisting motion. In this example, the lateral motion can occur at a relatively low frequency (e.g., at DC frequency ranges) to randomize a point of contact of the body 504 with a contact pad. In some examples, the movement of the body 504 can be applied at or proximate a lateral resonance of the MEMS device 500 and/or the body 504, thereby advantageously enabling effective elimination of stiction when stiction occurs.

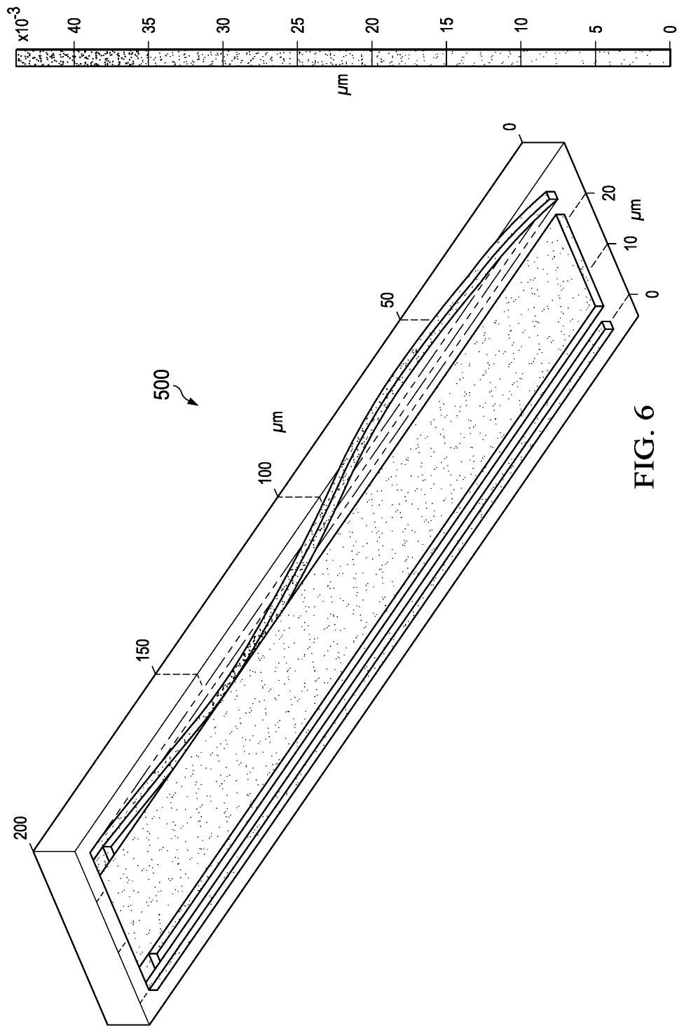

FIG. 6 depicts example movement of the example MEMS device 500 of FIGS. 5A and 5B. As can be seen in FIG. 6, the lateral movement is significantly smaller than the overall dimensions of the MEMS device 500. In particular, the lateral motion is several degrees of magnitude smaller than the overall dimensions of the MEMS device 500.

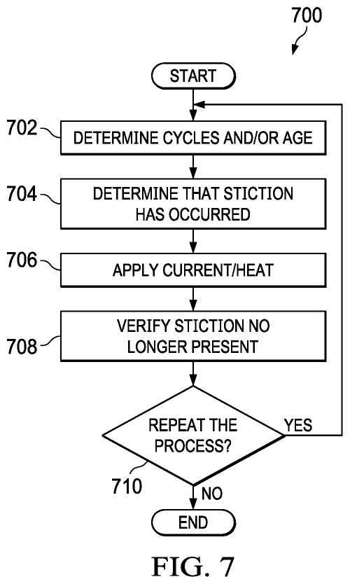

FIG. 7 is a flowchart representative of an example method 700 that may be performed to implement examples disclosed herein. The example method 700 can be performed periodically and/or when stiction has been detected/determined.

At block 702, in some examples, a number of cycles of a MEMS device (e.g., the MEMS device 100, the MEMS device 400, the MEMS device 500) and/or age (e.g., service life) of the MEMS device is determined. This determination can be utilized so that a body and/or a movable portion of the MEMS device can be moved.

At block 704, in some examples, it is determined whether stiction of the MEMS device has occurred. This determination can be utilized to operate the MEMS device to resolve the stiction.

At block 706, current and/or heat is applied to the MEMS device. In this example, current is applied to a spine (e.g., the spine 106, the spine 406, the spine 506) of the MEMS device, thereby heating the spine and causing the MEMS device to move relative to a contact point due to a thermal coefficient mismatch of first and second materials (e.g., layered first and second materials) of the MEMS device.

At block 708, in some examples, it is verified whether stiction is still present. This verification may occur based on whether the MEMS device can be toggled between on and off states/positions. For example, if the MEMS device cannot be toggled, it is determined that stiction is still present.

At block 710, it is determined whether to repeat the process. If the process is to be repeated (block 710), control of the process returns to block 702. Otherwise, the process ends.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

Example methods, apparatus and articles of manufacture described herein improve reliability of MEMS devices. Examples disclosed herein can significantly increase a number of cycles that a MEMS switch can maintain functionality. Examples disclosed herein can reduce and/or mitigate stiction. Examples disclosed herein are power efficient and relatively compact in comparison to known solutions to mitigate and/or resolve stiction.

Example methods, apparatus, systems, and articles of manufacture to thermally actuate MEMS devices are disclosed herein. Further examples and combinations thereof include the following:

Example 1 includes a microelectromechanical structures (MEMS) switch comprising a body having a first end and a second end opposite the first end, the body extending from a base and having a first width, a bridge extending laterally from the body at the second end, and a spine extending between the bridge and the base, the spine having a second width smaller than the first width, at least one of the spine or the body including a first material with a first thermal coefficient and a second material with a second thermal coefficient different from the first thermal coefficient.

Example 2 includes the MEMS switch of example 1, wherein the spine is a first spine and the bridge is a first bridge, and further comprising a second bridge laterally extending from the body, and a second spine extending from the base to the second bridge.

Example 3 includes the MEMS switch of example 1, wherein the first material is at a first depth of at least one of the spine or the body and the second material is at a second depth of the at least one of the spine or the body.

Example 4 includes the MEMS switch of example 1, wherein the first material is at a first lateral side of at least one of the spine or the body and the second material is at a second lateral side of the at least one of the spine or the body.

Example 5 includes the MEMS switch of example 1, wherein the first material is at a first longitudinal side of at least one of the spine or the body and the second material is at a second longitudinal side of the at least one of the spine or the body.

Example 6 includes the MEMS switch of example 1, further comprising a vertical bias electrode that is coupled to the body, the vertical bias electrode to move the body.

Example 7 includes the MEMS switch of example 1, wherein the first material is at least partially composed of at least one of tungsten or platinum.

Example 8 includes the MEMS switch of example 7, wherein the second material is at least partially composed of silicon dioxide or titanium.

Example 9 includes the MEMS switch of example 1, wherein a ratio of the second width to the first width is in a range from 1 3 to 1:80.

Example 10 includes an apparatus comprising a microelectromechanical structures (MEMS) switch circuit having an output and an input, a contact pad, a body configured to be movable to toggle the MEMS switch circuit between on and off states based on the body contacting the contact pad, the body supporting a bridge that extends laterally therefrom, the body having a first width, and a spine extending from the bridge, the spine having a second width smaller than the first width, the spine configured to be heated when current passes therethrough to cause a thermal coefficient mismatch of at least one of the body or the spine to move the body relative to the contact pad.

Example 11 includes the apparatus of example 10, wherein the spine is a first spine, the bridge is a first bridge, and further comprising a second bridge extending laterally from the body, and a second spine extending from the base to the second bridge.

Example 12 includes the apparatus of example 10, wherein the body is configured to move via a mechanism separate from heating the spine.

Example 13 includes the apparatus of example 10, wherein the body is configured to move laterally relative to the contact pad based on the thermal coefficient mismatch.

Example 14 includes the apparatus of example 13, wherein the body is configured to move laterally at a lateral resonance of the body.

Example 15 includes the apparatus of example 10, wherein the body is configured to contact the contact pad at random points of contact based on the current passing through the spine to prevent stiction between the body and the contact pad.

Example 16 includes a system comprising a contact pad of a microelectromechanical structures (MEMS) switch, a base, a body positioned between the base and the contact pad, the body configured to move toward and contact the contact pad to electrically couple the contact pad to the base, the body having a first width, a spine extending from a bridge that extends laterally from the body, the spine having a second width smaller than the first width, at least one of the body or the spine having a first material with a first thermal coefficient and a second material with a second thermal coefficient different from the first thermal coefficient to define a thermal coefficient mismatch therebetween, and a current source configured to cause current to pass through the spine and heat the spine to move the body relative to the contact pad based on the thermal coefficient mismatch.

Example 17 includes the system of example 16, wherein the body is a first body and the bridge is a first bridge, and further comprising a second body extending from the first body via a second bridge.

Example 18 includes the system of example 17, wherein the first body is electrically isolated from the second body.

Example 19 includes the system of example 17, wherein the second body is movable to electrically coupled a radio frequency (RF) input and an RF output.

Example 20 includes the system of example 17, further comprising a vertical bias electrode that is coupled to the second body, the vertical bias electrode configured to move the second body.

Example 21 includes the system of example 16, wherein the current source is to cause the current to pass through the spine as a pulse waveform.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value.

Modifications are possible in the described embodiments, and other embodiments are possible, within the scope of the claims. Any element and/or feature of the described embodiments can be combined and/or utilized with any other of the described embodiments.

What is claimed is:

1. A microelectromechanical structures (MEMS) switch comprising:
a body having a first end and a second end opposite the first end, the body extending from a base at the first end and having a first width;
a bridge extending laterally from the body at the second end; and
a spine extending between the bridge and the base, the spine having a second width smaller than the first width, at least one of the spine or the body including a first material with a first thermal coefficient and a second material with a second thermal coefficient different from the first thermal coefficient.

2. The MEMS switch of claim 1, wherein the spine is a first spine and the bridge is a first bridge, and further comprising:
a second bridge laterally extending from the body; and
a second spine extending from the base to the second bridge.

3. The MEMS switch of claim 1, wherein the first material is at a first depth of at least one of the spine or the body and the second material is at a second depth of the at least one of the spine or the body.

4. The MEMS switch of claim 1, wherein the first material is at a first lateral side of at least one of the spine or the body and the second material is at a second lateral side of the at least one of the spine or the body.

5. The MEMS switch of claim 1, wherein the first material is at a first longitudinal side of at least one of the spine or the body and the second material is at a second longitudinal side of the at least one of the spine or the body.

6. The MEMS switch of claim 1, further comprising a vertical bias electrode that is coupled to the body, the vertical bias electrode to move the body.

7. The MEMS switch of claim 1, wherein the first material is at least partially composed of at least one of tungsten or platinum.

8. The MEMS switch of claim 7, wherein the second material is at least partially composed of silicon dioxide or titanium.

9. The MEMS switch of claim 1, wherein a ratio of the second width to the first width is in a range from 1:3 to 1:80.

10. An apparatus comprising:
a microelectromechanical structures (MEMS) switch circuit having an output and an input,
a contact pad;
a body configured to be movable to toggle the MEMS switch circuit between on and off states based on the body contacting the contact pad, the body supporting a bridge that extends laterally therefrom, the body having a first width; and
a spine extending from the bridge, the spine having a second width smaller than the first width, the spine configured to be heated when current passes therethrough to cause a thermal coefficient mismatch of at least one of the body or the spine to move the body relative to the contact pad.

11. The apparatus of claim 10, wherein the spine is a first spine, the bridge is a first bridge, and further comprising:
a second bridge extending laterally from the body; and
a second spine extending from the base to the second bridge.

12. The apparatus of claim 10, wherein the body is configured to move via a mechanism separate from heating the spine.

13. The apparatus of claim 10, wherein the body is configured to move laterally relative to the contact pad based on the thermal coefficient mismatch.

14. The apparatus of claim 13, wherein the body is configured to move laterally at a lateral resonance of the body.

15. The apparatus of claim 10, wherein the body is configured to contact the contact pad at random points of contact based on the current passing through the spine to prevent stiction between the body and the contact pad.

16. A system comprising:
a contact pad of a microelectromechanical structures (MEMS) switch;
a base;
a body positioned between the base and the contact pad, the body configured to move toward and contact the contact pad to electrically couple the contact pad to the base, the body having a first width;
a spine extending from a bridge that extends laterally from the body, the spine having a second width smaller than the first width, at least one of the body or the spine having a first material with a first thermal coefficient and a second material with a second thermal coefficient different from the first thermal coefficient to define a thermal coefficient mismatch therebetween; and
a current source configured to cause current to pass through the spine and heat the spine to move the body relative to the contact pad based on the thermal coefficient mismatch.

17. The system of claim 16, wherein the body is a first body and the bridge is a first bridge, and further comprising a second body extending from the first body via a second bridge.

18. The system of claim 17, wherein the first body is electrically isolated from the second body.

19. The system of claim 17, wherein the second body is movable to electrically coupled a radio frequency (RF) input and an RF output.

20. The system of claim 17, further comprising a vertical bias electrode that is coupled to the second body, the vertical bias electrode configured to move the second body.

21. The system of claim 16, wherein the current source is to cause the current to pass through the spine as a pulse waveform.
